(19) United States
(12) Patent Application Publication
(10) Pub. No.: US 2010/0126336 A1
(43) Pub. Date: May 27, 2010

(54) OPTICALLY TRANSMISSIVE ARMOR COMPOSITE AND METHOD OF MANUFACTURE

(76) Inventor: RICHARD L. COOK, Flagstaff, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/464,400

(22) Filed: May 12, 2009

Related U.S. Application Data
(63) Continuation-in-part of application No. 11/295,016, filed on Dec. 5, 2005, now abandoned.
(60) Provisional application No. 60/633,365, filed on Dec. 3, 2004.

(51) Int. Cl. F41H 5/04; B32B 17/10

(52) U.S. Cl. 89/36.02; 156/106

(57) ABSTRACT

An exemplary, substantially optically transparent armor composite is disclosed as comprising: a first layer comprising a first glass material; a second layer comprising an articulated second glass material; a third layer comprising a kinetic energy absorbing urethane material; and an inter-layer comprising a thermoset elastomer disposed between the first layer and the second layer, between the second layer and the third layer, and among articulated elements of the second layer, wherein the elastomer is in-situ cured at a temperature from about 70° F. to about 110° F. Disclosed features and specifications may be variously controlled, adapted or otherwise optionally modified to improve and/or modify the performance characteristics of the transparent/translucent armor composite. Exemplary embodiments of the present invention generally provide lightweight transparent armor for use as, for example, bulletproof windows in vehicles and buildings.

### RELATED APPLICATIONS

This continuation-in-part application claims priority to U.S. Provisional Patent Application Ser. No. 60/633,365 (entitled ‘Transparent Armor’) filed in the United States Patent and Trademark Office on Dec. 3, 2004 and to Non-Provisional patent application Ser. No. 11/295,016 (entitled ‘Optically Transmissive Armor Composite’) filed in the United States Patent and Trademark Office on Dec. 5, 2005 by Richard Cook.

### FIELD OF INVENTION

The present invention generally provides for improved systems, devices, compositions, and methods for substantially transparent, breakage-resistant composite structures. More particularly, the present invention generally relates to bullet-resistant windows and/or ballistic laminate materials. In exemplary embodiments of the present invention, the systems, devices, compositions, and methods relate to ballistic glass and transparent armor useful in military and/or security vehicle applications. Still some other exemplary embodiments of the present invention relate to architectural and design elements for security purposes in hostile environments.

### BACKGROUND

In recent times, security, in all aspects of human activity, be it business, personal, home, and/or vehicular, has become increasingly important. For example, military vehicles by nature require greater than average protection for their occupants. This need for heightened protection has given rise to various transparent armor structures for windshields, side windows, rear windows, etc., that are designed to resist the incursion of projectiles, such as, ammunition, small arms projectiles, shrapnel, etc. Additionally, transparent armor structures (“shields”) are also desired that not only resist the incursion of projectiles but that also limit resultant cracking from an impact to a limited diameter range or to a small area that surrounds the point of impact. Shields are also desired that deter and/or restrict crack propagation and/or crack failure across a major portion of the shield or across the entire shield.

In conventional transparent armor construction (“bullet-proof glass”), multiple layers of glass and clear plastic sheet are bonded together to form complex composites. Close inspection of these forms of multi-layered materials reveal layers of silica glass, interleaved with, and/or backed by a ductile plastic sheet. The interleaved layer or layers of plastic act as an internal crack stopper, and a backing layer acts as a spall catcher. This resulting combination is very efficient at resisting single projectile strikes, but is generally inferior at defeating multiple strikes, particularly strikes in close proximity to one another. Even a single strike can cause widespread optical damage across the majority of the shield area.

Acrylic (e.g. “PMMA”), polycarbonate (“PC”), and polyurethane (“PU”) based materials are among the plastic materials that exhibit utility in producing typical transparent armor composites. How these materials are used usually depends on the specific ballistic threat.

First, Acrylic (“PMMA”), has excellent tensile properties, but is very hard and has almost no ductility, i.e., low elongation under load, thus PMMA can easily spall and may only be useful for armor when backed by a ductile material, e.g., PC or PU.

Secondly, though not as hard as PMMA, PC has superior tensile and ductile properties over a wide temperature range, thus historically PC is the material of choice for everything from safety glasses to armor spall shields. It has a long history of use, dating back nearly a half century. PC's primary disadvantages are poor solvent and scratch resistance and lack of ballistic performance when applied in sheet thickness greater than ¼ inch. PC backings once abraded or attacked by solvents, cannot be restored to optical clarity and the window must be discarded. Hard coatings can be used to partially remedy this problem, but are expensive and tend to compromise the ductility of the spall layer.

Thirdly, PU can be formulated in a wide range of hardness and strength. For example, high hardness PU formulations comprising a Shore D value of about 85 demonstrate great penetration resistance but with a few exceptions, tend to crack under high energy impact. On the other hand, lower hardness PU formulations, in the range of about Shore D79-83, provide superb ductility and tend to resist cracking under high energy impact. PU also has notable penetration advantages over PC primarily because PU does not have the thickness constraints of PC, and PU is also exceptionally resistant to most solvents. Ideally, monolithic form urethane polymers are able to greater sustain bullet strikes as close as ½ inch apart without cracking, and often when strikes are closer or even coincidental.

The earliest commercial use of optically clear urethanes was by Goodyear Aerospace circa 1970. It was used in the form of laminated acrylic/urethane aircraft canopies, capable of resisting high velocity impacts, for example, from bird-strikes. Around 1990, Simula, Inc. developed ductile, optically clear urethane armor capable of stopping small arms projectiles, e.g., 9 mm, 357 and 44 magnum rounds, but the company did not pursue bullet blunting hard polymers, nor did they consider using glass faces to blunt high velocity pointed projectiles.

Using new, improved, and harder variants to the Simula Inc. formula, high velocity impact tests fired upon specimens showed excellent penetration resistance to soft-nosed 30-06 hunting ammunition because the bullet “mushroomed” and presented a large frontal face to the impacted polymer. Conversely, a similar, fully-jacketed 30-06 M-80 round failed to deform (“mushroom”) and easily penetrated the specimen. It was discovered though, that by placing a thin pane of glass over the specimen, the bullet point was blunted and resulting penetration behaved the similarly to the soft nosed hunting round. Succeeding specimens with the glass bonded to the specimen by a thin layer of a urethane elastomer showed multiple strikes to the specimen could be sustained in close proximity to one another with little damage to the surrounding specimen area.

### SUMMARY OF THE INVENTION

In accordance with exemplary embodiments, the present invention provides systems, devices, compositions, and methods for providing bullet resistant windows (e.g., ballistic glass) using at least one thin laminate glazing adhered to at least one ductile, energy absorbing urethane polymer backing by an in-situ cured, thermoset elastomer that is disposed between the glazing and the backing. This unique configuration allows the bullet resistant windows to sustain multiple, close proximity strikes from a variety of munitions, such as conventional shoulder fired rounds, that result in only localized “cracking” at the impact site, while retaining the optically transmissive properties for the remainder of the window.

Advantages of the present invention will be set forth in the Detailed Description which follows and the advantages may be apparent from the Detailed Description or may be learned by practice of exemplary embodiments of the invention. Still other advantages of the invention may be realized by means of any of the instrumentalities, methods, or combinations particularly disclosed herein.

### BRIEF DESCRIPTION OF THE DRAWINGS

Representative elements, operational features, applications, and/or advantages of the present invention reside in the details of construction and operation as more fully hereafter depicted, described and claimed—reference being made to the accompanying drawings forming a part hereof, wherein like numerals refer to like parts throughout. Other elements, operational features, applications, and/or advantages may become apparent in light of certain exemplary embodiments recited in the Detailed Description, wherein:

FIG. 1 representatively illustrates an isometric view of a substantially optically transmissive armor composite in accordance with an exemplary embodiment of the present invention;

FIG. 2 representatively illustrates an isometric view of another substantially optically transmissive armor composite in accordance with an exemplary embodiment of the present invention;

FIG. 3 representatively illustrates an isometric view of yet another substantially optically transmissive armor composite in accordance with an exemplary embodiment of the present invention;

FIG. 4 representatively illustrates an isometric view of still yet another substantially optically transmissive armor composite in accordance with an exemplary embodiment of the present invention;

FIG. 5 representatively illustrates an isometric view of another substantially optically transmissive armor composite in accordance with an exemplary embodiment of the present invention;

FIG. 6 representatively illustrates an isometric view of still another substantially optically transmissive armor composite in accordance with an exemplary embodiment of the present invention; and

FIG. 7 representatively illustrates a flow chart of a method for manufacturing a substantially optically transmissive armor composite in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various exemplary embodiments of the present invention. Furthermore, the terms “first”, “second”, and the like herein, if any, are generally used for distinguishing between similar elements and not necessarily for describing a sequential or chronological order. Moreover, the terms “front”, “back”, “top”, “bottom”, “over”, “under”, and the like, if any, are generally employed for descriptive purposes and not necessarily for comprehensively describing exclusive relative position or order. Any of the preceding terms so used may be interchanged under appropriate circumstances such that various embodiments of the invention described herein, for example, are capable of operation in orientations and environments other than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following representative description is intended to provide convenient illustrations for implementing various embodiments of the invention. As will become apparent, changes may be made in the function and/or arrangement of any of the elements described in the disclosed exemplary embodiments without departing from the spirit and scope of the invention.

In the past, multiple layers of glass comprising thicknesses in the vicinity of ½″ were used in ballistic glass applications. The resultant peripheral damage from a projectile (ammunition) strike, both to ballistic integrity and to optical clarity, was severe and broad in scope. To mitigate such damage, various embodiments of the present invention provide for a tough kinetic backing layer comprising an overlying, relatively thin glass facing. The glass facing, being of sufficient thickness (e.g., ⅛″) to spoil (“blunt”) the pointedness of the incoming projectile, may be bonded to the kinetic layer by an in-situ cured, thermoset elastic medium. Thus, when a projectile strikes the thin glass facing, the facing fractures, but in a much smaller area than that of thicker conventional ballistic glass assemblies.

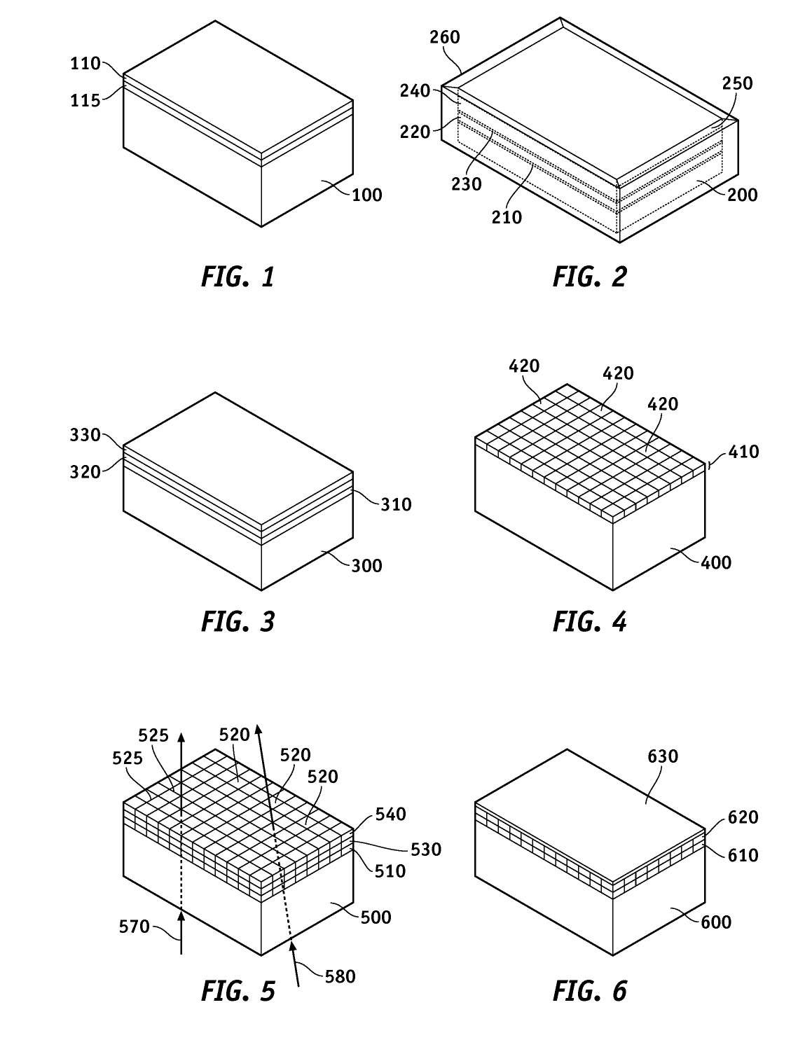

In accordance with an exemplary embodiment and representatively depicted in FIG. 1, the present invention provides for an improved optically transmissive armor composite. The optically transmissive armor composite may comprise of a multi-layered construction assembly, which may comprise: a first layer 110 (e.g., a ‘facing layer’ presenting a surface of first contact to blunt an incoming projectile); a second layer 100 (e.g., a ‘kinetic layer’ for depleting the projectile's energy); and an in-situ cured, thermoset elastomeric bonding layer 115 partially disposed therebetween (e.g., an ‘inter-layer’) and suitably configured to immobilize the facing layer 110 with respect to the disposition of the kinetic layer 100. More particularly, in accordance with another exemplary embodiment, the optically transmissive armor composite may comprise the multi-layered construction assembly to comprise: a) a strike face comprising a hard thin glazing, such as an ⅛″ thick high silica glass, for example, facing layer 110; b) at least one kinetic layer, such as a urethane, comprising a Shore D value from about 79 to about 85, for example, kinetic layer 100; and c) an in-situ cured, thermoset elastomeric inter-layer to bond the entire assembly, for example, bonding layer 115 to bond facing layer 110 to kinetic layer 100.

The facing layer 110 may comprise of a hard, glass-like material that operates to blunt or otherwise deform a bullet or projectile incident to its surface. The facing layer 110 material may comprise of various compositions, for example: soda lime; crown; borosilicate; aluminum oxynitride; sapphire; etc., but any glass material, whether now known or otherwise hereafter described in the art, may be alternatively, conjunctively or sequentially employed to achieve a substantially similar result.

In accordance with an embodiment of the present invention, the facing layer 110 may be suitably configured to substantially blunt a projectile striking the surface of the facing layer 110, as described, but may act to also partially remove a coaxial portion of the projectile striking the surface of the facing layer 110. The facing layer 110 may diminish structural integrity of the coaxial portion of the projectile striking the surface of the facing layer 110, and may partially deform the shape of the projectile striking the surface of the facing layer 110.

In accordance with an exemplary embodiment, the kinetic layer 100 of the optically transmissive armor composite may generally comprise of a tough, semi-rigid material comprising high cut and puncture resistance capable of “catching” the blunted projectile by depleting its kinetic energy. For example, a single casting of a clear, hard urethane polymer may comprise of an exemplary material that may be employed in accordance with various exemplary embodiments of the present invention. Hard urethane has demonstrated ease of casting and provides superior close-strike resiliency. Other materials comprising similar characteristics (e.g., polycarbonate and acrylic), whether now known or otherwise hereafter described in the art, may be alternatively, conjunctively or sequentially employed to achieve a substantially similar result.

In accordance with an exemplary embodiment, and as generally illustrated in FIG. 2, an optically transmissive armor composite may comprise of interspersed kinetic layers 200, 220, 240 that may comprise about ¼″ urethane material bonded together by relatively thin, about 0.004 to about 0.008 inch thick inter-layers of in-situ cured thermoset elastomer layers 210, 230 in combination with a relatively thin, about ⅛″ to about ¼″, hard facing glass layer 250. In one exemplary embodiment, interspersed kinetic layers 200, 220, and 240 may comprise of progressively varying hardness levels. For example, the kinetic layers 200, 220, and 240 may vary from harder to softer (more ductile) layers, wherein kinetic layer 220 may be softer than kinetic layer 200, and kinetic layer 240 may be softer still than layer 220. Conversely, in another example, the kinetic layers 200, 220, and 240 may vary from softer to harder layers, wherein kinetic layer 220 may be harder than kinetic layer 200, and kinetic layer 240 may be harder still than layer 220. In still yet another example, the kinetic layers may comprise a mixture of hardness levels, for example, kinetic layers 200 and 240 may comprise relatively hard layers and kinetic layer 220 may comprise a relatively softer layer than kinetic layers 200 and 240, and vice versa. Moreover, while the above exemplary embodiments are illustrated as comprising three interspersed kinetic layers, other exemplary embodiments may comprise additional layers or fewer layers, and the layers may comprise varying hardness levels or the layers may comprise equivalent hardness levels.

In accordance with one particular exemplary embodiment, an optically transmissive armor composite may comprise a multiple layered construction comprising: a) a strike face of a hard, thin glazing, usually high silica glass, for example, facing layer 250; b) a second layer, for example, kinetic layer 240 comprising a hard (about Shore D-79 to about Shore D-85) urethane or other hard polymer e.g. PMMA; c) at least one other backing layer, for example, kinetic layer(s) 220 and/or 200 comprising a more ductile polyurethane material, Shore D80 or lower; and d) thin highly elastic inter-layers, for example, inter-layers 210 and/or 230 preferably in-situ cured, to bond the entire assembly together.

In accordance with an exemplary embodiment, a bonding inter-layer, for example inter layer 115, inter-layers 210 and 230, etc., may be in-situ cured and comprise of a thermoset elastomeric material comprising high elongation characteristics, or any other suitable material capable of mitigating temperature-related expansion differentials, for example, between the kinetic layer 100 and the facing layer 110, between the kinetic layer 240 and the facing layer 250, and between the various kinetic layers 200, 220, and 240, etc. If the bonding inter-layer does not comprise suitable elongation characteristics over a given temperature range, the bonding inter-layer may become damaged should the first and second layers expand or contract differentially, which may result in delamination. In accordance with exemplary embodiments, the inter-layer material may comprise a tensile strength at least about 3,000 psi and wherein the adhesive strength of the inter-layer material comprises at least the same value as the tensile strength. Moreover, the inter-layer material may comprise characteristic elongation at of at least 400%.

In an exemplary embodiment, an in-situ cured bonding inter-layer may comprise a polyester or a polyether based urethane comprising an amine or hydroxyl curative. Such composition is configured to allow for near room temperature cures, and demonstrate strength retention at temperatures in excess of 300° F. as well as elasticity retention at temperatures down to about −60° F. Moreover, the adhesive strength of the inter-layer may be augmented by addition of small quantities of silane agents, for example, Dow A-1100. These compositions may enhance the performance of large laminates of materials comprising widely disparate expansion coefficients. To minimize shear stress between the strike face, the kinetic layer(s), and the in-situ cured elastomeric inter-layer(s), the layers may be bonded at or near the median operational temperature, for example, about room temperature, (e.g., from about 70° F. to about 110° F.). In sum, the relatively low temperature, in-situ cured bonding inter-layer comprises the bonding method that imparts the present invention assembly's unique characteristics and provides for structural and optical transmissive integrity of the armor composite throughout operational temperatures that may range from about −40° F. to about 200° F.

In an exemplary embodiment, the in-situ cured bonding inter-layer may not only hind the various facing and/or kinetic layers together, but the inter-layer material may also be applied to encase, either partially or completely, the edges of the composite, i.e. around the perimeter, for example, as shown in FIG. 2 as element 260. In this embodiment, the inter-layer material provides for slight cushioning to prevent the edges of the composite structure from “chipping” during installation. In practice, many ballistic glass composite shields/windows are compromised by installation. If the edges become chipped or cracked, then the entire assembly must be replaced, thereby incurring unnecessary costs for the user. By applying a thin layer, about 1/16″ to about ⅛″ thick, of inter-layer material around the perimeter of the assembly, such chipping and cracking by wayward installers/installation can be averted.

In accordance with the various exemplary embodiments described, it should be noted that the term “projectile” may refer to any object that may strike the surface of an optically transmissive armor composite assembly. These may include projectiles used to attack the integrity of the optically transmissive armor composite such as ballistic items (bullets, shrapnel, thrown objects such as bricks, stones and other similar objects) and self-propelled items (such as RPGs, missiles, and other rocket-like objects). Projectiles may also include objects used to directly strike the surface of the optically transmissive armor, such as, for example: bricks, metal objects, stones, etc. Finally, projectiles may also include other objects that come into contact with the surface of the optically transmissive armor composite. For example, if the optically transmissive armor composite is used as part of a vehicle and that vehicle were to be involved in an accident; projectiles may comprise parts of other vehicles, a road, buildings or other objects that strike the surface of the composite.

In accordance with various exemplary embodiments of the present invention, significant benefits may be derived from the optically transmissive armor composite comprising polymeric kinetic layers and elastomeric inter-layers comprising various thickness dimensions in combination with the relatively thin, hard facing layer. In an exemplary embodiment, a facing layer, for example facing layer 110, may comprises a thickness of about ⅛″ (±approximately 50%), but may comprise thicknesses up to about ¼″. This is in contrast to the conventional art, in which the principle structure of the conventional art comprises of a plurality of thick glass layers that are primarily used as kinetic depletion layers rather than as facing and blunting layers. In the present invention, the glass, facing layer material may generally serve to blunt or otherwise deform a projectile that is striking its surface, as opposed to depleting a substantial fraction of the kinetic energy of the projectile. Accordingly, glass facing layers in accordance with the present invention may be relatively thin compared to those of the conventional art. Furthermore, a thinner layer of glass material may significantly reduce the weight of the armor composite assembly without substantially decreasing penetration impedance. The thinner layer of glass material may also simultaneously provide improved optical characteristics and retention of localized structural integrity and optical clarity after the armor composite assembly is struck by a projectile. Moreover, among exemplary embodiments it has been demonstrated that the thinner layer of glass material may also act to disperse the shockwave imparted upon the assembly when struck by a projectile. For example, when the composite assembly is struck by a projectile, the induced shockwave from an impact may be absorbed by the thinner layer of glass material and the shockwave energy may be laterally dispersed across the glass layer. In this manner, less energy from the impact is transmitted to other layers of the assembly, and because less energy is transferred to the other layers of the assembly, the other layers may more easily impede the projectile from penetrating the composite assembly.

For comparable stopping power, the present invention weighs considerably less than that of conventional transparent armor composite alternatives. Optical clarity after a projectile strike (i.e., strike proximity performance) is also improved. As the thickness of the glass facing material decreases, the damaged area (i.e., strike radius) and glass loss also decreases. For example, the glass loss (or fracture) in a ⅛″ glass facing is only about 1″ diameter extending radially outward from the point of impact; however, with ¼″ glass facing, this area extends out to roughly about 3″ in diameter. Accordingly, after a strike upon a thinner layer of glass, less of the material's optical characteristics will have been compromised.

By way of comparison, the optical occlusion of conventional transparent armor can extend out over a 6″ radius or more from any given strike. Various exemplary embodiments of the present invention may incur an occluded area of only about 1.5″ radius under similar conditions. Second strike capability (i.e., the ability of the optically transmissive armor assembly to stop a projectile that strikes its surface in close proximity to the location of a prior strike) is substantially improved due to the minimized glass loss that results from use of thinner layers of glass facing. Generally, the glass loss area after a first strike is greatly weakened and will not provide much protection against a second strike. Accordingly, it is preferable to employ a thinner layer of glass material in the facing layer, thereby minimizing the amount of glass loss. Thus, the present invention operates to overcome many problems associated with the conventional art by providing a strike stoppage capability in ¾″ spacing, or less, in all directions.

In accordance with an exemplary embodiment, an optically transmissive armor composite may comprise the various layers to comprise indicies of refraction that are substantially similar. In this manner, any distorted viewing across the composite may be minimized by selecting materials that not only provide superior ballistic stoppage capabilities, but also comprise substantially similar indicies of refraction. In an exemplary armor composite, the armor composite may comprise of a borosilicate glass as the facing layer material, wherein the borosilicate glass may comprise a refractive index of about 1.48. The armor composite may further comprise of a low modulus, low temperature curing urethane (as described above) as the elastomeric bonding inter-layer, which bonds the facing layer to the kinetic. In this example, to provide for optimal viewing performance, the inter-layer and the kinetic layer may comprise of a material comprising substantially similar indicies of refraction to the facing layer, e.g. comprising of a refractive index of about 1.48±0.05. Furthermore, by addition of low refractive index plasticizers, for example, by addition to the elastomeric bonding inter-layer and/or kinetic layer, the index of refraction match can be nearly perfect. Although it is generally preferable to match the indices of refraction for most applications, in another example, substantial benefit may be derived from an optically transmissive armor composite where the indices of refraction are dissimilar. For example, even with mismatched indices of refraction, an optically transmissive armor composite may still function well under a variety of conditions in diverse operating environments.

In accordance with another exemplary embodiment, as generally depicted in FIG. 3, the facing layer may comprise of more than one sheet of material, for example, multiple facing layers 310, 320, and/or 330 that overly a relatively thicker kinetic layer, for example, kinetic layer 300. Suitable configurations of the facing layer may comprise two sheets of glass material 310, 320; or the facing layer may comprise more than two sheets of glass material 310, 320, 330. It will be understood that although specific dimensions for the facing material have been provided vide supra, significant benefit may be derived from the use of other dimensions as well. For example, the thicknesses of glass facing material may be significantly altered and still provide substantial benefit over the conventional art.

In accordance with still another exemplary embodiment, and as generally depicted in FIG. 4, a first facing layer 410 may be substantially articulated. Articulation of the first facing layer 410 has demonstrated minimization of glass loss that may result after a projectile strikes the surface of the first facing layer 410 by inter alia localizing fracture expansion to a single tile (or nearest-neighbors) regime. Accordingly, the loss of facing material when struck by a projectile may generally be confined to a particular tile or a limited plurality of tiles. In accordance with exemplary embodiments, the articulated layer may range from about ¼″ to about 6″.

In an exemplary embodiment, the facing layer 410 may be articulated with the plurality of tile elements 420 that may comprise different shapes, including, for example: discrete square tiles (as generally depicted in FIG. 4); rectangles, hexagons, and/or other regular shapes. The various tiles 420 may be coupled together with any suitable polymer matrix, for example, an elastomeric bonding material similar to the elastomeric bonding inter-layer material 115, 210, 230, and the like. Also, as discussed previously, one aspect of an articulated embodiment may comprise closely matching the indices of refraction of the optically transmissive tile elements 420 with that of the polymer matrix to eliminate or otherwise reduce optical distortions across articulated element boundaries. For example, and with reference to FIG. 5, it is apparent that by viewing through the composite at a vantage point that is normal to the various layers, direction line 570, the articulated layer will not inhibit the clarity of viewing. In other words, by looking straight on through the articulated layers, any boundaries may only be slightly perceptible as thin lines. Thus, as long as each of the layers is transparent, viewing is not distorted. However, as demonstrated by direction line 580, if the indices of refraction are not closely matched, looking “across” the boundaries of the articulated layer could significantly hinder viewing through the composite.

In accordance with yet another exemplary embodiment, and as generally depicted in FIG. 5 for example, the facing may comprise more than one layer of substantially articulated glass material 510, 530, 540. The articulation may be accomplished via a plurality of tile elements 520. Tile elements 520 may comprise different shapes, including, for example: discrete square tiles (as generally depicted in FIG. 5); rectangles, hexagons, and/or other regular shapes. In the representative embodiment illustrated in FIG. 5, boundaries 525 of tile elements 520 in the sheets of glass facing 540, 530, 510 may be suitably configured so as to not substantially overlap, thus by aligning the tile element boundaries with one another, the optical clarity can be maximized. Should a projectile strike a boundary 525 of a tile 520, experimentation has shown that the projectile may still be sufficiently blunted, and the kinetic layer 500 can still effectively stop or otherwise impede the projectile.

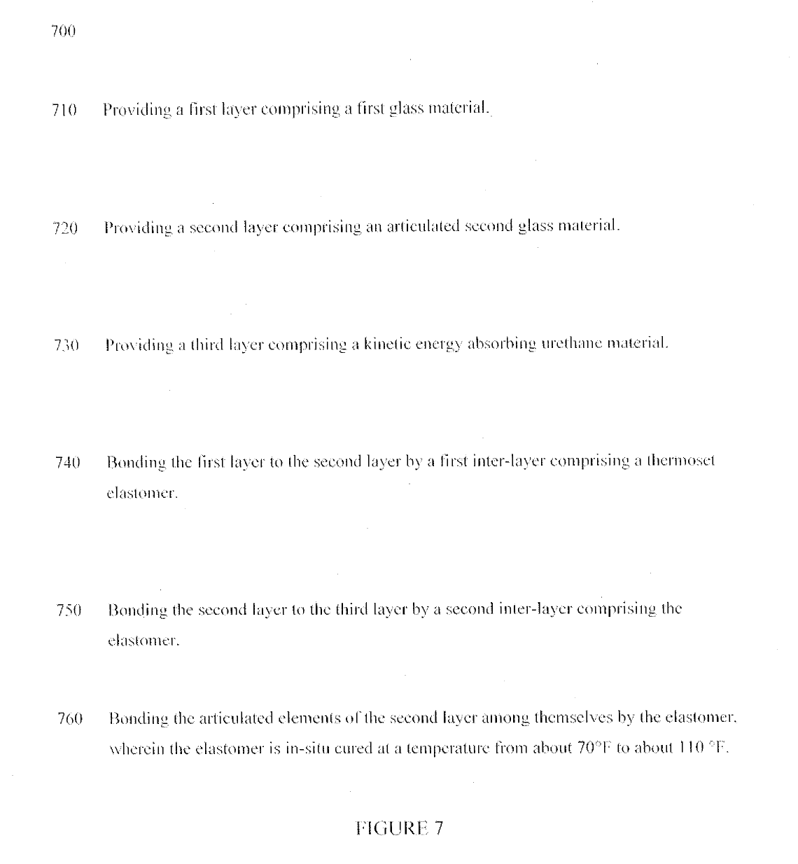

In accordance with another exemplary embodiment, as generally depicted in FIG. 6 for example, the facing may comprise more than one layer of glass material 610, 620, 630, wherein overlying facing layer 630 may be substantially contiguous (non-articulated), so as to prevent or otherwise impede dirt and/or other materials from lodging in the interstitial regions between the tile elements of articulated layers 610, 620. It should be noted that although the exemplary embodiment illustrated in FIG. 6 shows articulated layers 610 and 620 beneath the smooth top layer 630, an alternate embodiment may comprise of only a single articulated layer beneath the smooth top layer 630. The tile components or articulated layers 610 and 620 may comprise various types of shapes, including, for example: discrete square tiles (as generally depicted in FIG. 6); rectangles, hexagons, and/or other regular shapes. In the exemplary embodiment illustrated in FIG. 6, the boundary edges between the tile elements in the articulated sheets of glass facing 610, 620 may be suitably configured so as to substantially not overlap, as similarly shown among the articulated tiles in FIG. 5. Such a configuration may find particular utility in specific applications where optical clarity is to be maximized—especially where the indices of refraction between the tile elements (as well as between overlying and underlying layers) can be well-matched.

In accordance with one exemplary embodiment, an optically transmissive armor composite may comprise: a) a first layer comprising a strike face of a hard, thin glazing, usually high silica glass or a high hardness polymer, for example, facing layer 630; b) a second layer comprising an articulated layer, which may be relatively thick in nature and comprise of other hard glass or crystalline substance, e.g. sapphire, for example, articulated layer(s) 610 and/or 620; c) a ductile kinetic energy-absorbing layer, comprising a Shore D 79-85 transparent urethane polymer, for example, kinetic layer 600; and d) a thin, highly elastic bonding inter-layers (not shown), in-situ cured, to bond the entire assembly together.

In sum, in accordance with various exemplary embodiments of the present invention, the optically transmissive armor composite may comprise any combination or permutation of number of layers, types of layers, and/or thickness of layers. For example, the armor composite may comprise one, two, three or more facing layers to blunt a striking projectile, and in general comprises facing layers that are relatively thin. The facing layers may comprise of a single smooth layer or may comprise of an articulated layer or any combination thereof. The armor composite may further comprise of one, two, three, or more kinetic layers to absorb and/or disperse the impact energy of a striking projectile, wherein multiple layers may vary in thickness, hardness, ductility, etc. The armor composite may also comprise of elastomeric, bonding inter-layers to bond the various facing layers and/or kinetic layers to each other by an in-situ cured thermosetting method. The armor composite may also comprise substantially matching indices of refraction between the facing layers, kinetic layers, inter-layers, articulated layers, etc., to maximize optical clarity and performance through a wide range of operational conditions and temperatures.

In accordance with an exemplary embodiment, optically transmissive armor composite assemblies may be constructed using vacuum and autoclave processes of laminate stack-ups. The stack-ups may comprise a combination of multi-layered thick glass, polymeric inner-layers, and polymeric backing as described. Various other embodiments of the present invention may also be manufactured with conventional equipment, and methods such as open face casting and/or a resin transfer method may be likewise be employed.

In accordance with an exemplary embodiment, an optically transmissive armor composite assembly may be constructed by open face pouring an uncured elastomer (inter-layer material) onto a substrate, for example, a kinetic layer, then placing a subsequent layer, for example, a facing layer, onto the pour. This is only done with relatively small, flat planes and accomplished by canting the top layer onto the elastomer puddle and gradually decreasing the angle of impingement, thereby pushing the wet elastomer in a “wave” until the two substrate surfaces are parallel. This avoids entrapment of air bubbles.

In accordance with another exemplary embodiment, a more controllable method of assembly may be to clamp the two substrates together, for example, the facing layer and the kinetic layer, using spacer shims around the edges to form adequate separation, and injecting the elastomeric inter-layer material into the interstice. This allows the casting of compound contours and multiple layers in a single injection sequence. The operation can be accelerated by initiating the process at elevated temperatures and allowing cooling to occur as polymerization progresses. Initial cure can be achieved relatively quickly while still allowing quick de-mold times; final cure can then occur at room temperatures over a relatively long time period.

In accordance with yet another exemplary embodiment of the present invention, and with respect to the articulated embodiments, the individual tiles that comprise the articulated layer may be assembled by placing a layer “puddle” of interlayer material upon a layer the articulated layer is to be coupled and individually placing each tile about ¼″ apart from adjacent tiles. Upon completion of setting the tiles that comprise the articulated layer, the complete articulated tile layer array may be compressed, i.e., pushed together, to force the inter-layer material up, between, and over the top of each of the individual tiles. Such compression thus flushes out an entrained air ahead of the flow. Next, any subsequent layer that may be placed over the articulated layer, for example, a facing layer, may be positioned and thereby encapsulating the articulated layer. In another exemplary embodiment, the articulated layer may be fabricated under a vacuum, to avoid any air entrapment, and the entire layer pre-cured between parallel platens. In this manner, a ready-to-use articulated sheet is produced and may be further assembled to other layers as described, for example, by the above described canting procedure.

In accordance with an embodiment of the present invention and with reference to FIG. 7, an exemplary method 700 may comprise: providing a first layer comprising a first glass material (710); providing a second layer comprising a kinetic energy absorbing urethane material (720); bonding the first layer to the second layer by a first inter-layer comprising a thermoset elastomer (730), wherein the elastomer bonds the first layer to the second layer by an in-situ cure at a temperature from about 70° F. to about 110° F.

In the foregoing specification, the present invention has been described with reference to specific exemplary embodiments; however, it will be appreciated that various modifications and changes may be made without departing from the scope of the present invention as set forth herein. The specification and Figures are to be regarded in an illustrative manner, rather than a restrictive one, and all such modifications are intended to be included within the scope of the present invention. Accordingly, the scope of the invention should be determined by the claims and their legal equivalents rather than by merely the examples described above.

For example, the steps recited in any method or process claim may be executed in any order and are not limited to the specific order presented in the claims. Additionally, the components and/or elements recited in any apparatus embodiment may be assembled or otherwise operationally configured in a variety of permutations to produce substantially the same result as the present invention and are accordingly not limited to the specific configuration recited in the claims.

Benefits, other advantages, and solutions to problems have been described above with regard to particular embodiments; however, any benefit, advantage, solution to problem, or any element that may cause any particular benefit, advantage, or solution to occur or to become more pronounced are not to be construed as critical, required, or essential features, or components of the invention.

As used herein, the terms “comprising”, “having”, “including” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A substantially optically transmissive armor composite comprising:
a first layer comprising a first glass material;
a second layer comprising an articulated second glass material;
a third layer comprising a kinetic energy absorbing urethane material; and
an inter-layer comprising an elastomer disposed between the first layer and the second layer, between the second layer and the third layer, and among articulated elements of the second layer, wherein the elastomer is in-situ cured at a temperature from about 70° F. to about 110° F.

2. The armor composite of claim 1, wherein the first layer comprises a thickness from about 0.09 inches to about 0.25 inches.

3. The armor composite of claim 1, wherein the second layer comprises a thickness from about 0.25 inches to about 6.0 inches.

4. The armor composite of claim 1, wherein the first layer is suitably configured to at least one of: substantially blunt a projectile striking a surface of the first layer; at least partially remove a coaxial portion of the projectile striking the surface of the first layer; at least partially diminish a structural integrity of the coaxial portion of the projectile striking the surface of the first layer; and at least partially deform a shape of the projectile striking the surface of the first layer.

5. The armor composite of claim 1, wherein the third layer comprises a Shore D hardness range from about Shore D 79 to about Shore D 85.

6. The armor composite of claim 1, suitably configured upon an impact by a projectile to limit optical distortion of the armor composite to no greater than about 1 inch radially outward from a point of the impact along a surface plane of the first layer when the first layer comprises a thickness of about 0.09 to about 0.12 inches.

7. The armor composite of claim 1, suitably configured upon an impact by a projectile to limit optical distortion of the armor composite to no greater than about 3 inches radially outward from a point of the impact along a surface plane of the first layer when the first layer comprises a thickness of about 0.20 to about 0.25 inches.

8. The armor composite of claim 1, wherein structural and optical transmissive integrity of the armor composite are maintained throughout operational temperatures that range from about −40° F. to about 200° F.

9. The armor composite of claim 1, wherein the inter-layer comprises a tensile strength at least about 3,000 psi.

10. The armor composite of claim 9, wherein an adhesive strength of the inter-layer comprises at least the tensile strength of the inter-layer.

11. The armor composite of claim 1, wherein the inter-layer comprises,
an adhesive strength at least as equal to its tensile strength; and comprises
an elongation at failure of at least 400%.

12. A method for manufacturing a substantially optically transmissive armor composite comprising:
providing a first layer comprising a first glass material;
providing a second layer comprising an articulated second glass material;
providing a third layer comprising a kinetic energy absorbing urethane material; and
bonding the first layer to the second layer by a first inter-layer comprising a thermoset elastomer;
bonding the second layer to the third layer by a second inter-layer comprising the elastomer; and
bonding the articulated elements of the second layer among themselves by the elastomer;
wherein the elastomer is in-situ cured at a temperature from about 70° F. to about 110° F.

13. The method of claim 12, wherein the first layer comprises a thickness from about 0.09 inches to about 0.25 inches.

14. The method of claim 12, wherein the second layer comprises a thickness from about 0. 25 inches to about 6.0 inches.

15. The method of claim 12, wherein the first layer is suitably configured to at least one of: substantially blunt a projectile striking a surface of the first layer; at least partially remove a coaxial portion of the projectile striking the surface of the first layer; at least partially diminish a structural integrity of the coaxial portion of the projectile striking the surface of the first layer; and at least partially deform a shape of the projectile striking the surface of the first layer.

16. The method of claim 12, wherein the third layer comprises a Shore D hardness range from about Shore D 79 to about Shore D 85.

17. The method of claim 12, wherein the composite is suitably configured upon an impact by a projectile to limit optical distortion of the armor composite to no greater than about 1 inch radially outward from a point of the impact along a surface plane of the first layer when the first layer comprises a thickness of about 0.09 to about 0.12 inches.

18. The method of claim 12, wherein the composite is suitably configured upon an impact by a projectile to limit optical distortion of the armor composite to no greater than about 3 inches radially outward from a point of the impact along a surface plane of the first layer when the first layer comprises a thickness of about 0.20 to about 0.25 inches.

19. The method of claim 12, wherein structural and optical transmissive integrity of the armor composite are maintained throughout operational temperatures that range from about −40° F. to about 200° F.

20. The method of claim 12, wherein the inter-layer comprises a tensile strength at least about 3,000 psi.

21. The method of claim 20, wherein an adhesive strength of the inter-layer comprises at least the tensile strength of the inter-layer.

22. The method of claim 12, wherein the inter-layer comprises,
an adhesive strength at least as equal to its tensile strength; and comprises
an elongation at failure of at least 400%.
